(19) United States
(12) Patent Application Publication
(10) Pub. No.: US 2009/0249475 A1
(43) Pub. Date: Oct. 1, 2009

(54) AUTHENTICATION SYSTEM, ELECTRONIC APPARATUS, ELECTRONIC APPARATUS AUTHENTICATION METHOD, AND COMPUTER-READABLE RECORDING MEDIUM HAVING AUTHENTICATION PROGRAM RECORDED THEREON

(75) Inventor: Satoshi OHAKA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, KAWASAKI (JP)

(21) Appl. No.: 12/364,847

(22) Filed: Feb. 3, 2009

(30) Foreign Application Priority Data
Mar. 31, 2008 (JP) 2008-090208

(51) Int. Cl. G06F 21/00

(52) U.S. Cl. 726/16

(57) ABSTRACT

An authentication system includes a communication unit that originates a call on the basis of an entered telephone number, a vibration reception unit that receives vibrations generated by a portable device in response to an incoming call, vibration pattern registration unit registering a vibration pattern, and an authentication unit that performs authentication by determining whether or not a vibration pattern of the vibrations received by the vibration reception unit matches the vibration pattern registered in the vibration pattern registration unit.

### CROSS-REFERENCE TO RELATED APPLICATIONS

This application is based upon and claims the benefit of priority of the prior Japanese Patent Application No. 2008-90208, filed on Mar. 31, 2008, the entire contents of which are incorporated by reference herein.

### BACKGROUND

1. Field

The present technique relates to user authentication for electronic apparatuses such as personal computers (PCs), and more particularly, to an authentication system performing user authentication by using a telephone communication function of an electronic apparatus, to an electronic apparatus, to an electronic apparatus authentication method, and to a computer-readable recording medium having an authentication program recorded thereon.

2. Description of the Related Art

In order to achieve protection against unauthorized use of electronic apparatuses, such as PCs, personal authentication is performed by entering a password or the like on the basis of a basic input/output system (BIOS) program. In addition, an authentication system in which personal authentication is performed by using a telephone communication function of an electronic device such as a cellular phone owned by an individual is known.

Concerning such personal authentication, conventional authentication has been performed by causing a computer system to transmit a barcode image for authentication to a cellular phone in advance. The barcode image is displayed on a display unit of the cellular phone, causing the barcode image to be scanned by a scanner of the system. Alternatively, authentication has been performed by causing a system to transmit a voice representing a password to a cellular phone and causing a microphone of the system to receive the voice by using the cellular phone. Alternatively, authentication has been performed by registering authentication information on a user who owns a portable terminal into a server and causing an optical reader device of a system to read the authentication information on the basis of an optical signal transmitted from the portable terminal. Alternatively, authentication has been performed by registering an image for authentication into an apparatus to be authenticated, displaying the image on a display unit of a portable terminal, and causing a light-receiving unit of the apparatus to receive the image and to perform comparison.

Concerning personal authentication for PCs, if authentication is performed by using only a PC, if the PC is stolen, unauthorized use of the PC cannot be prevented. In addition, if a device different from a PC is used for authentication; a user of the PC needs to carry the PC and the device with them. Since, in general, users own a communication device, such as a cellular phone, as a communication unit, it is not problematic for a user to carry such a communication device and an electronic apparatus, such as a PC, with them.

Thus, an object of the present technique relates to authentication using a communication function of a portable device or the like and is to improve the security and convenience of an electronic apparatus.

### SUMMARY

In order to achieve the above object, according to an authentication system, an electronic apparatus, an electronic apparatus authentication method, and a computer-readable recording medium having an authentication program recorded thereon of the present technique, a vibration pattern to be used for authentication of an apparatus to be authenticated is registered in a portable device, and the portable device generates vibrations in response to an incoming call. The apparatus to be authenticated detects a vibration pattern generated by the portable device, and compares the detected vibration pattern with the registered vibration pattern to determine whether or not the detected vibration pattern matches the registered vibration pattern. Thus, with the use of the portable device that a user of the apparatus carries with them, personal authentication is performed by using a telephone communication function of the apparatus and an authentication function of determining whether or not the vibration pattern generated by the portable device in response to the incoming call matches the vibration pattern registered in the apparatus. Consequently, the security and convenience of the electronic apparatus can be improved.

The above-described embodiments of the present invention are intended as examples, and all embodiments of the present invention are not limited to including the features described above.

### BRIEF DESCRIPTION OF THE DRAWINGS

FIG. 1 illustrates an authentication system according to a first embodiment;

FIG. 2 illustrates an authentication operation performed by the authentication system;

FIG. 3 illustrates an authentication function;

FIG. 4 illustrates the configuration of a PC according to a second embodiment;

FIG. 5 illustrates the configuration of a portable device;

FIG. 6 is a flowchart showing a process of the initial settings of the portable device;

FIG. 7 is a flowchart showing a process of the initial settings of the PC;

FIG. 8 illustrates an authentication data registration screen;

FIG. 9 is a flowchart showing a process of registration of authentication data;

FIG. 10 illustrates a vibration pattern;

FIG. 11 illustrates vibration patterns; and

FIG. 12 is a flowchart showing an authentication process.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

### First Embodiment

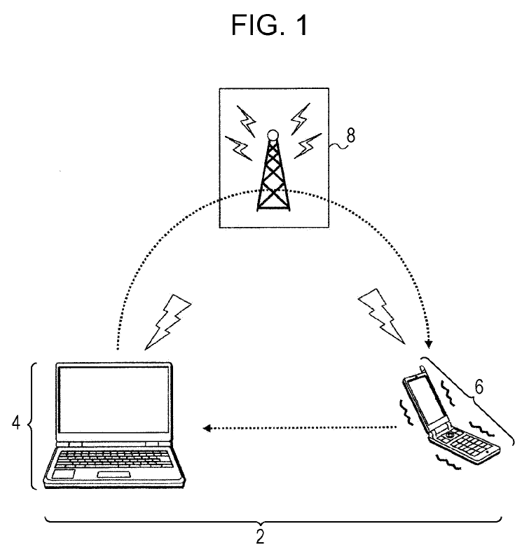

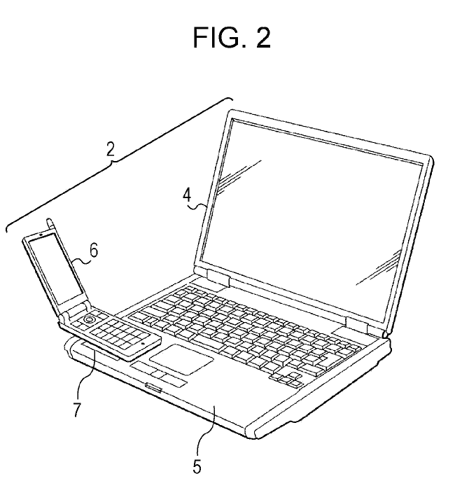

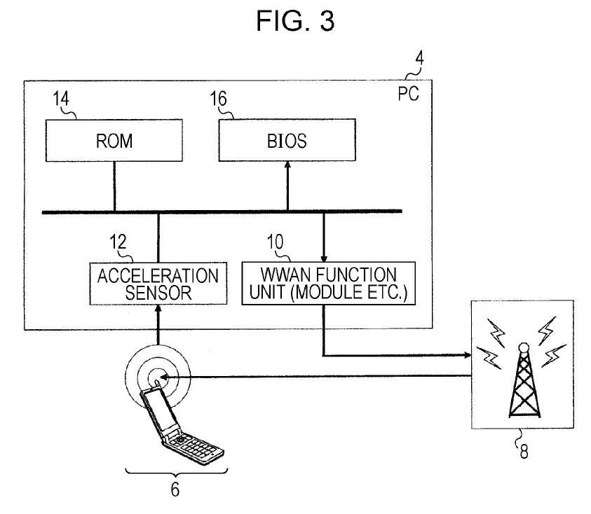

A first embodiment will be described with reference to FIGS. 1, 2, and 3. FIG. 1 illustrates an authentication system. FIG. 2 illustrates an authentication operation performed by the authentication system. FIG. 3 illustrates an authentication function. FIGS. 1 to 3 are merely examples. The present technique is not limited to the features shown in FIGS. 1 to 3.

An authentication system 2 is an example of an authentication system, an authentication method, or an authentication program according to the present technique. As shown in FIG. 1, the authentication system 2 is a system that performs user authentication by using a PC 4 and a portable device 6. The PC 4 is an electronic apparatus to be subjected to user authentication. The PC 4 has an authentication function and a telephone communication function similar to that of the portable device 6. The telephone communication function is, for example, a function of allowing connection to a wireless wide area network (WWAN). The telephone communication function is a network function of allowing, with the use of a cellular phone communication function, connection to the WWAN.

A telephone connection to the portable device 6 is established through a base station 8 when the PC 4 originates a call to the telephone number of the portable device 6. The portable device 6 vibrates with a vibration pattern representing the incoming call in response to the incoming call. If the portable device 6 is placed on a vibration receiving unit 7 of a casing 5 of the PC 4 as shown in FIG. 2, the PC 4 detects vibrations generated by the portable device 6 with the vibration receiving unit 7.

The PC 4 includes a WWAN function unit 10, an acceleration sensor 12, a read-only memory (ROM) 14, and a BIOS 16, as shown in FIG. 3. The WWAN function unit 10 is an example of communication unit and is used for telephone communication with the portable device 6.

The acceleration sensor 12 is an example of vibration reception unit. The acceleration sensor 12 receives vibrations generated by the portable device 6. For example, a unit provided as a collision detection unit to be used in order to avoid data corruption of a hard disk drive (HDD) in a general PC may be used as the acceleration sensor 12. The acceleration sensor 12 is capable of detecting accelerations (G) on x, y, and z axes. In this case, the acceleration sensor 12 is capable of detecting the degree of acceleration in a certain direction applied to the PC 4. This function can be used as unit for detecting the pattern of vibrations generated by the portable device 6.

The ROM 14 is an example of storage unit. A program such as BIOS 16 and various data are stored in the ROM 14. In addition, a specific vibration pattern is registered as a registered pattern in the ROM 14. The registered pattern is authentication information. The vibration pattern is the pattern of vibrations generated by the portable device 6 in response to an incoming call from the user of the PC 4. The vibration pattern is registered in advance in an address book of the portable device 6.

The BIOS 16 is a program group to be used for controlling peripheral devices, such as providing input/output unit for an operating system (OS) and an application program. In this embodiment, the BIOS 16 serves as comparison unit and constitutes a lock function unit. The BIOS 16 compares an acquired pattern with a registered pattern and permits or prohibits startup of the PC 4 in accordance with a result of the comparison. If the PC 4 originates a call to the portable device 6 and a vibration pattern generated by the portable device 6 in response to the incoming call matches a vibration pattern registered in the PC 4, the user of the portable device 6 is determined to be the same as the user of the PC 4 and authentication is successfully completed. In this case, the PC 4 can be started.

Since the user of the PC 4 always carries the portable device 6 with them, security in the authentication system 2 can be ensured with the use of the portable device 6. In addition, an improvement in convenience, such as facilitation of personal authentication, can be achieved without requiring a special device or the like.

If vibrations of the portable device 6 are detected by the acceleration sensor 12, in this embodiment, time is plotted on the abscissa axis and accelerations applied at a point in time are plotted on x, y, and z axes. For example, assuming that authentication is performed by storing a vibration pattern detected within a predetermined time, such as six seconds, the following pattern data can be registered:

registered pattern=1, 0, 0, 1, 1, 0,

Where “1” represents a state in which the portable device 6 vibrates, and “0” represents a state in which the portable device 6 does not vibrate. In this case, the state in which the portable device 6 vibrates is obtained when an acceleration of a specified value or more is detected on any one of the x, y, and z axes. Taking into consideration the way to place the portable device 6 and a change in the orientation of the portable device 6 due to vibrations, individual values of outputs of the acceleration sensor 12 on the x, y, and z axes or outputs indicating the directions of vibrations (plus direction or minus direction) are not necessarily used for the determination of a pattern. However, in order to improve the accuracy of authentication, the values of outputs on individual axes or outputs indicating the directions of vibrations may be referred to.

As is clear from the above description of this embodiment, automatic authentication of the PC 4 can be performed at the startup of the PC 4 with the use of the portable device 6 in the authentication system 2, in accordance with origination of a call from the PC 4 and reception of the call at the portable device 6.

In conventional authentication, authentication is often performed by using only a PC. Thus, if the PC is stolen, the PC may be illegally used. However, in this embodiment, since authentication is performed, with a portable device that a user in general always carries with them, by using a function provided in many existing portable devices, security and convenience can be ensured by addition of only a small number of functions.

### Second Embodiment

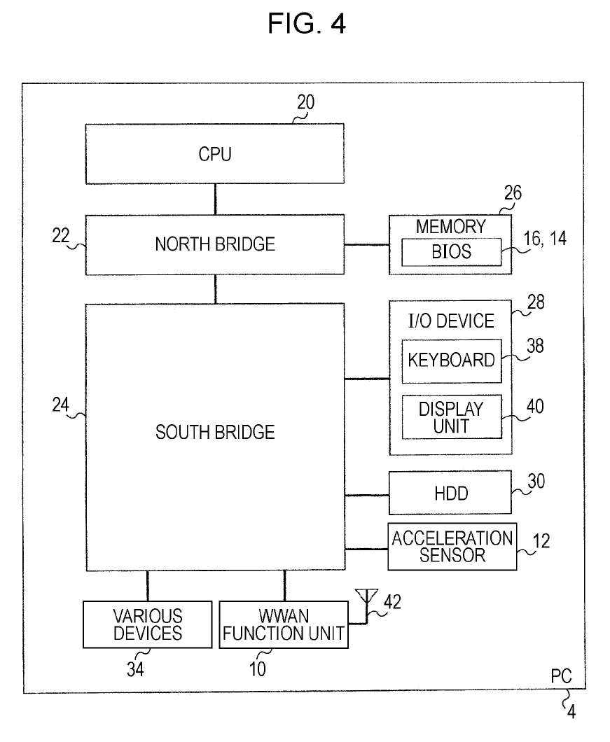

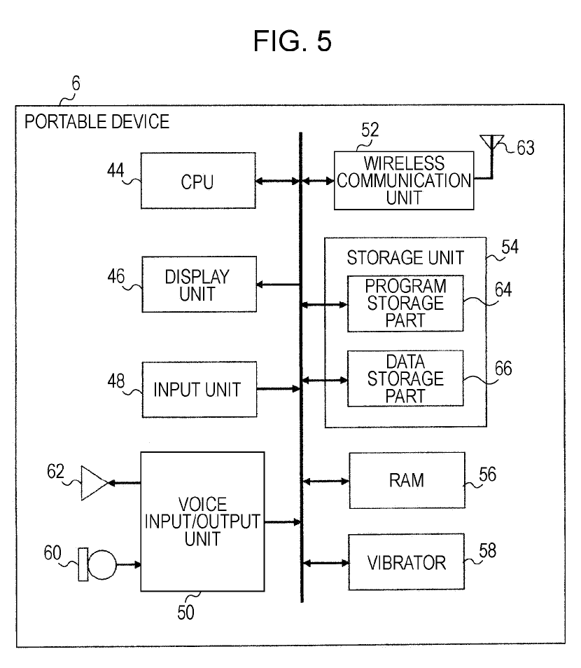

A second embodiment will be described with reference to FIGS. 4 and 5. FIG. 4 illustrates the configuration of a PC 4. FIG. 5 illustrates the configuration of a portable device 6. FIGS. 4 and 5 are merely examples. The present technique is not limited to the features shown in FIGS. 4 and 5. In FIGS. 4 and 5, the same parts as in FIGS. 1, 2, and 3 are denoted by the same reference numerals.

The PC 4 is an example of an electronic apparatus to be subjected to user authentication. The PC 4 has a telephone communication function of performing telephone communication with the portable device 6 and a security function of starting the PC 4 after personal authentication is successfully completed. The security function is a function of starting the PC 4 and performing necessary operations on the basis of personal authentication. The PC 4 includes, as shown in FIG. 4, a central processing unit (CPU) 20, a north bridge 22, a south bridge 24, a memory 26, an input/output (I/O) device 28, an HDD 30, the acceleration sensor 12, various devices 34, and the WWAN function unit 10.

The CPU 20 serves as unit for performing various control operations, such as authentication control and control of registration of a vibration pattern, and arithmetic operation. The CPU 20 executes an OS, an application program, an authentication program routine stored in the HDD 30; the BIOS 16 (see FIG. 3) stored in the memory 26, and the like. The CPU 20 also serves as authentication unit for performing comparison of vibration patterns. The BIOS 16 includes an authentication program, in which a vibration pattern is used as authentication information, and the like.

The north bridge 22 is a chip set constituting a peripheral component interconnect (PCI) bus and serves as unit for transferring data among the CPU 20, the memory 26, and the south bridge 24. The south bridge 24 is a chip set constituting a PCI bus and serves as unit for performing data processing on an input/output side.

The memory 26 serves as recording unit including a random-access memory (RAM) and the ROM 14 (see FIG. 3). The BIOS 16 and the like are stored in the ROM 14. The RAM forms a work area.

The I/O device 28 serves as input/output unit. The I/O device 28 is constituted by, for example, a keyboard 38 and a display unit 40. The HDD 30 serves as external storage unit and stores an OS, an application program, and the like.

The acceleration sensor 12 serves as unit for receiving acceleration applied to the PC 4 and detecting the acceleration. In this embodiment, the acceleration sensor 12 serves as vibration reception unit for receiving vibrations applied to the PC 4 and vibration detection unit for detecting the received vibrations.

The WWAN function unit 10 is an example of communication unit for performing origination and reception of calls in a wireless manner. The WWAN function unit 10 includes an antenna 42 and performs origination and reception of calls in WWAN communications.

The portable device 6 includes a computer. The portable device 6 serves as unit for performing telephone communication with the PC 4. As shown in FIG. 5, the portable device 6 includes a CPU 44, a display unit 46, an input unit 48, a voice input/output unit 50, a wireless communication unit 52, a storage unit 54, a RAM 56, and a vibrator 58.

The CPU 44 is an example of control unit. The CPU 44 performs execution of an OS and an application program stored in the storage unit 54, control of origination and reception of calls, and output control of a vibration pattern necessary for authentication.

The display unit 46 is an example of information provision unit. The display unit 46 includes, for example, a liquid crystal display (LCD) unit. The input unit 48 is an example of information input unit. The input unit 48 includes a keyboard including letter keys to be used for entering letters, dial keys, cursor keys, an enter key, and the like. The voice input/output unit 50 serves as unit for receiving and transmitting voices. The voice input/output unit 50 includes a microphone 60 for receiving voices and a receiver 62 for transmitting voices.

The wireless communication unit 52 is an example of communication unit for performing origination and reception of calls in a wireless manner. The wireless communication unit 52 includes an antenna 63 and performs origination and reception of calls in WWAN communications.

The storage unit 54 is an example of recording unit for recording programs and data. The storage unit 54 includes a program storage part 64 and a data storage part 66. The storage unit 54 can be constituted by a storage element serving as recording unit. The program storage part 64 is an example of storage unit for storing an OS, an application program, and the like. A database of an address book and the like is established in the data storage part 66. A vibration pattern corresponding to an incoming call from the PC 4 is registered as a registered pattern in the data storage part 66. The RAM 56 forms a work area.

The vibrator 58 is an example of vibration generation unit for generating vibrations representing an incoming call. The vibrator 58 generates vibrations having a vibration pattern representing an incoming call from the WWAN function unit 10 of the PC 4.

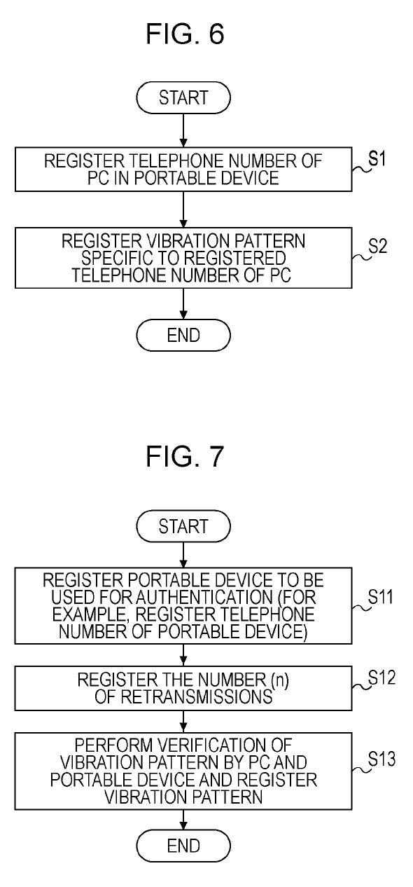

The initial settings of the portable device 6 will now be described with reference to FIG. 6. FIG. 6 is a flowchart showing a process of the initial settings of the portable device 6. The feature shown in FIG. 6 is merely an example. The present technique is not limited to the feature.

The process of the initial settings of the portable device 6 is an example of an authentication method or an authentication program and includes processes such as registration of the telephone number of the PC 4 in the portable device 6 to be used for authentication of the PC 4, registration of a vibration pattern, and the like.

As shown in FIG. 6, as the process of the initial settings of the portable device 6, the telephone number of the PC 4 is registered (operation S1). That is, the telephone number of the PC 4, which is a call originator, is registered in the database of address book data stored in the data storage part 66. Then, a vibration pattern specific to the registered telephone number of the PC 4 is registered (operation S2). Then, the process of the initial settings of the portable device 6 is completed. That is, the registered vibration pattern is authentication information of the PC 4. When receiving an incoming call from the PC 4, the portable device 6 generates vibrations having the vibration pattern corresponding to the PC 4 in accordance with the telephone number of the PC 4, from which the call is originated, as address information.

In the initial settings, by registering the vibration pattern specific to the telephone number of the PC 4 to be authenticated, an operation carried out in accordance with a different telephone number, that is, a so-called “spoofing”, can be avoided.

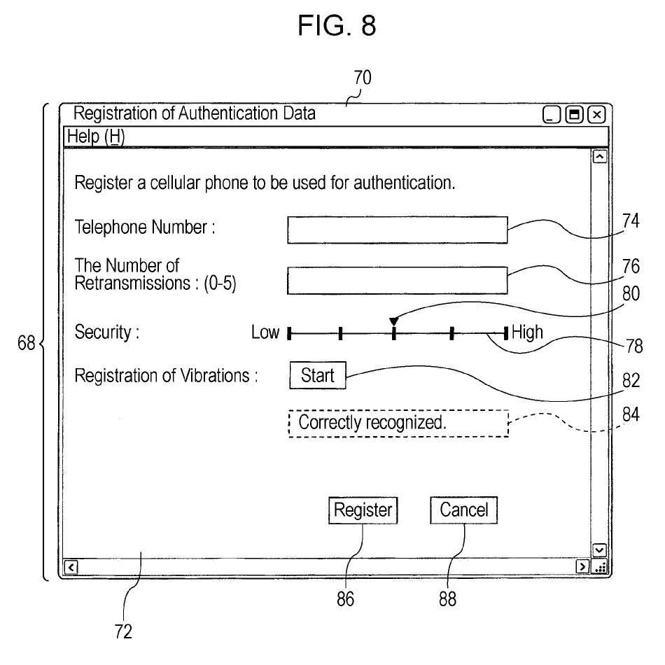

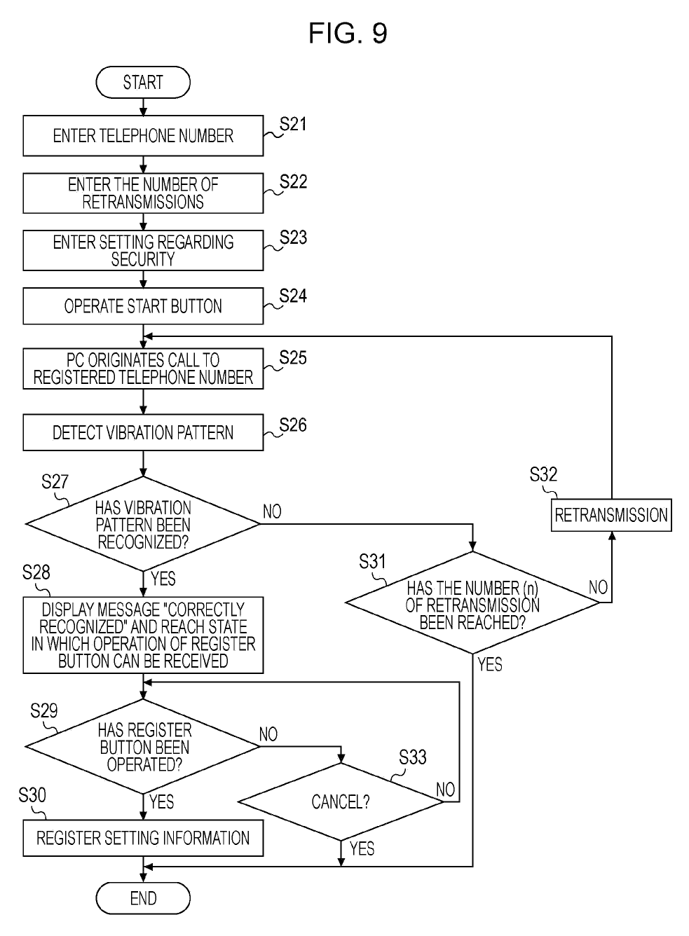

The initial settings of the PC 4 will now be described with reference to FIGS. 7, 8, and 9. FIG. 7 is a flowchart showing a process of the initial settings of the PC 4. FIG. 8 illustrates an authentication data registration screen. FIG. 9 is a flowchart showing a process of registration of authentication data. The features shown in FIGS. 7, 8, and 9 are merely examples. The present technique is not limited to the features.

The process of the initial settings of the PC 4 and the process of registration of authentication data are examples of an authentication method or an authentication program. The process of the initial settings of the PC 4 and the process of registration of authentication data include processes such as registration of the telephone number of the portable device 6 to be used for authentication of the PC 4, registration of the number of retransmissions, verification and registration of a vibration pattern, and the like.

As shown in FIG. 7, as the process of the initial settings of the PC 4, the telephone number of the portable device 6 to be used for authentication of the PC 4 is registered (operation S11), and the number (n) of retransmissions is registered (operation S12). Here, the number (n) of retransmissions represents the number of times retransmission can be performed if authentication is not completed. The number (n) of retransmissions is registered in the memory 26.

Verification of a vibration pattern is performed by the PC 4 and the portable device 6, and the vibration pattern is registered in the PC 4 (operation S13). Then, the initial settings of the PC 4 are completed. The vibration pattern is authentication information of the PC 4. The vibration pattern is a vibration pattern generated by the portable device 6 in response to an incoming call from the PC 4. In this case, registration of a vibration pattern in the PC 4 is performed by registration in the ROM 14 of the memory 26, which can be accessed by using the BIOS 16 (see FIG. 3).

In order to start the process of registration in the PC 4, an authentication data registration screen 68 is called and displayed as a window on the display unit 40 (see FIG. 4). An indication “registration of authentication data” is displayed in a title bar 70 on the authentication data registration screen 68, as shown in FIG. 8. An indication “Register a cellular phone to be used for authentication” is displayed in a content display area 72 as a message indicating the contents to be registered. An indication “telephone number:” is displayed below the indication “Register a cellular phone to be used for authentication”, and a telephone number entry field 74 is displayed. The telephone number of the portable device 6 can be entered in the telephone number entry field 74 by using the keyboard 38. The portable device is a communication destination to be used for authentication.

An indication “the number of retransmissions: (0-5)” is displayed below the indication “telephone number:” and the telephone number entry field 74. A number-of-retransmissions entry field 76 is displayed. In the number-of-retransmissions entry field 76, the number (n) of retransmissions, which has been described above, can be entered by using a numeric key of the keyboard 38. The number (n) of retransmissions may be 0. Entry of the number (n) of retransmissions does not cause rejection of call transmission.

An indication “security:” indicating registration of security level is displayed below the indication “the number of retransmissions: (0-5)” and the number-of-retransmissions entry field 76. A level setting bar 78 is displayed. By moving a cursor mark 80 provided above the level setting bar 78 toward left or right by using a cursor key so that the security level indicates a lower level or a higher level, a desired security level can be set.

An indication “registration of vibrations” is displayed below the indication “security:” and the level setting bar 78. A start button 82 to be used for starting registration of vibrations and a message display field 84 in which the success or failure of recognition of the setting contents is indicated is displayed. A register button 86 to be used for registration of authentication data and a cancel button 88 to be used for instructing cancellation of registration processing are displayed below the message display field 84. The enter key of the keyboard 38 is operated after a cursor is placed over the start button 82 in order to start registration of vibrations. The enter key of the keyboard 38 is operated after the cursor is placed over the register button 86 in order to perform registration of authentication data. The enter key of the keyboard 38 is operated after the cursor is placed over the cancel button 88 in order to cancel registration.

In the process of registration of authentication data, as described above, the telephone number of a cellular phone, the number of retransmissions, and a vibration pattern are registered as the initial settings of the PC 4. The authentication data registration screen 68 is displayed as a window when an initial setting program of the PC 4 is launched, as shown in FIG. 8. In the process of registration of authentication data, as shown in FIG. 9, entry of a telephone number (operation S21) and entry of the number of retransmissions (operation S22) are received, and entry of security setting (operation S23) is received. The level of security (see FIG. 8) is set in accordance with a vibration pattern, as described later. After the settings are completed, an operation of the start button 82 (operation S24) is received, and registration of the telephone number to be used for authentication is completed.

In response to the entry of the telephone number, the PC 4 originates a call to the registered telephone number (operation S25). The PC 4 detects the vibration pattern of vibrations generated by the portable device 6 (operation S26). The PC 4 determines whether a vibration pattern has been recognized (operation S27). If the PC 4 has recognized a vibration pattern (YES in operation S27), a message “Correctly recognized.” is displayed in the message display field 84 on the authentication data registration screen 68, and the PC 4 reaches a state in which an operation of the register button 86 can be received (operation S28).

In the state in which an operation of the register button 86 can be received, the PC 4 determines whether or not the register button 86 has been operated (operation S29). If the register button 86 has been operated (YES in operation S29), setting information is registered in the ROM 14 or the like that can be accessed by using the BIOS 16 in the memory 26 (operation S30). Then, the process of registration of authentication data is completed.

If a vibration pattern has not been recognized (NO in operation S27), the PC 4 reaches a retransmission mode and it is determined whether or not the set number (n) of retransmissions has been reached (operation S31). If the set number (n) of retransmissions has been reached (YES in operation S31), the process of registration of authentication data is terminated. If the set number (n) of retransmissions has not been reached (NO in operation S31), retransmission is performed (operation S32). Then, the process returns to operation S25. The retransmission operation is performed by using the telephone number entered in operation S21.

If the register button 86 has not been operated (NO in operation S29), it is determined whether or not the cancel button 88 has been operated (operation S33). If the cancel button 88 has not been operated (NO in operation S33), the process returns to operation S29 and the PC 4 reaches a standby mode. If the cancel button 88 has been operated (YES in operation S33), the process for registering setting information is canceled. Then, the process of registration of authentication data is terminated.

Note that if the cancel button 88 is operated, the registration operation is canceled and the program is terminated, irrespective of the stage of processing.

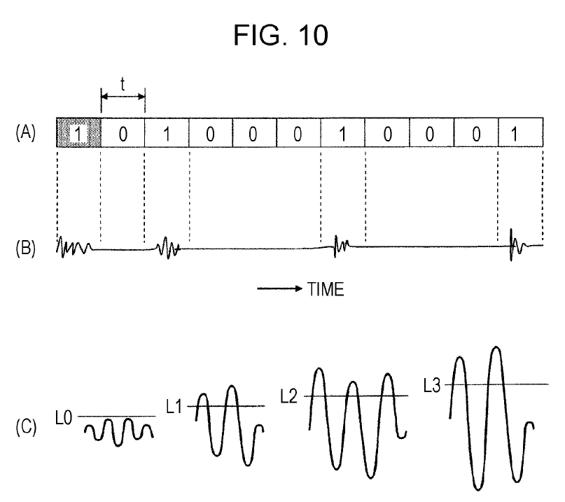

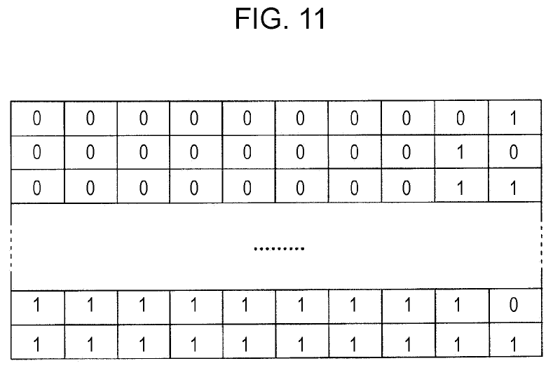

Setting of a vibration pattern will now be described with reference to FIGS. 10 and 11. FIG. 10 illustrates a vibration pattern. FIG. 11 illustrates vibration patterns. The features shown in FIGS. 10 and 11 are merely examples. The present technique is not limited to the features.

The portable device 6 is caused to generate vibrations in order to set a vibration pattern to be registered. The PC 4 determines whether or not vibrations are detected within a specific time and registers detected vibrations as a registered pattern. The PC 4 checks if a vibration occurs within each specific time t and creates a pattern while a case where a vibration occurs is set to “1” and a case where no vibration occurs is set to “0”. In this case, detection of vibrations is always started when a vibration occurs.

In order to improve the security, it is desirable to create a combination pattern of many vibrations. If setting of a vibration pattern is applied to actual products, a longer detection time reduces convenience, whereas a shorter specific time t increases the risk of misrecognition. Thus, maintaining the balance between the convenience and the risk of misrecognition is required.

In the security setting described above, the balance between the convenience and the risk of misrecognition can be changed. That is, if the security level is set to be lower, the authentication time is shortened and the specific time t is lengthened. However, if the security level is set to be higher, the specific time t is shortened and the authentication time is lengthened, thereby increasing the probability of misrecognition.

If a pattern “1, 0, 1, 0, 0, 0, 1, 0, 0, 0, 1” is set as a vibration pattern as shown in part (A) of FIG. 10, the time width of each of time sections indicated by “1” and “0” represents the specific time t. In this case, as shown in part (B) of FIG. 10, a vibration occurs within a time section represented by “1”, and no vibration occurs within a time section represented by “0”. The first time section represented by “1” represents a vibration to be used for starting detection and this time section is not included in a pattern to be registered. Thus, in the above example, a pattern of ten vibrations is recognized. In this case, a pattern “0, 1, 0, 0, 0, 1, 0, 0, 0, 1” is registered.

If the portable device 6 vibrates with the vibration pattern, the acceleration sensor 12 of the PC 4 determines whether or not an acceleration of a threshold or more is detected on any one of the x, y, and z axes.

For such a pattern of ten vibrations, that is, a 10-digit pattern, 1024 possible combinations (2¹⁰=1024) are available. As shown in FIG. 11, for example, a pattern of “0, 0, 0, 0, 0, 0, 0, 0, 0, 1”, a pattern of “0, 0, 0, 0, 0, 0, 0, 0, 1, 0”, . . . , and a pattern of “1, 1, 1, 1, 1, 1, 1, 1, 1, 1” can be available.

If the average of absolute values of accelerations generated in each vibration is considered as a vibration level, many more possible patterns can be obtained in accordance with the number of patterns and vibration levels. Thus, an improvement in the security can be achieved. For example, if four levels L0, L1, L2, and L3 are set for a pattern of ten vibrations as shown in part (C) of FIG. 10, a single vibration may be represented by four possible levels, that is, vibration levels L0 (=0), L1 (=1), L2 (=2), and L3 (=3). Thus, 4096 possible combinations (4×2¹⁰=2¹²=4096) can be obtained, and a higher security can be achieved.

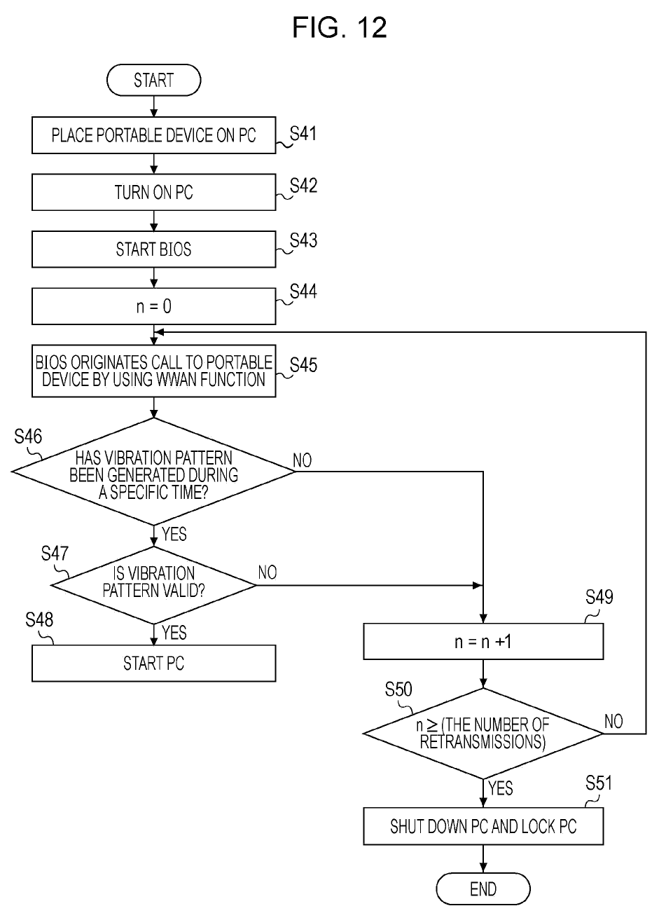

An authentication process for the use of the PC 4 will now be described with reference to FIG. 12. FIG. 12 is a flowchart showing an authentication process. The feature shown in FIG. 12 is merely an example. The present technique is not limited to the feature.

The authentication process is an example of an authentication method or an authentication program and includes processes such as authentication processing, startup of the PC 4 caused by successful authentication, and shutdown and locking of the PC 4 caused by unsuccessful authentication.

In the authentication process, as shown in FIG. 12, the portable device 6 is placed on the PC 4 (operation S41). The power of the PC 4 is turned on (operation S42), and electric power is supplied to the PC 4. In this case, the portable device 6 is placed on the vibration receiving unit 7 of the PC 4, and the PC 4 is started.

The BIOS 16 is started (operation S43), and the number (n) of times retransmission has been performed is set to 0 (operation S44). The BIOS 16 originates, with the WWAN function, a call to the portable device 6 (operation S45). In response to the call origination, when receiving the incoming call, the portable device 6 vibrates with a set vibration pattern. The PC 4 determines whether or not a vibration pattern has been generated within a specific time (operation S46). If a vibration pattern has been generated within the specific time (YES in operation S46), the PC 4 detects the vibration pattern and determines by comparison whether or not the vibration pattern is valid (operation S47). If it is determined that the vibration pattern is valid (YES in operation S47), that is, if the vibration pattern matches the registered pattern, authentication succeeds. Then, the PC 4 is switched from a locked state to an unlocked state, and the PC 4 is started (operation S48).

If a vibration pattern has not been generated within the specific time (NO in operation S46) or if the detected vibration pattern is not valid (NO in operation S47), the number n of times retransmission has been performed is updated (incremented by one, that is, n=n+1) (operation S49). Whether or not the number n of times retransmission has been performed has reached the set number of retransmissions is determined (operation S50). If the number n of times retransmission has been performed has not reached the set number of retransmissions (NO in operation S50), the process returns to operation S45 and retransmission is performed. If the number n of times retransmission has been performed has reached the set number of retransmissions (YES in operation S50), the PC 4 is shut down and the PC 4 is maintained in the locked state (operation S51). Then, the authentication process is terminated.

As described above, also in this embodiment, automatic authentication of the PC 4 can be performed at the startup of the PC 4 with the use of the portable device 6 in accordance with origination of a call from the PC 4 and reception of the call at the portable device 6. Thus, compared with a case where authentication is performed by using only a PC, unauthorized use by stealing or the like can be avoided. Moreover, since authentication is performed, with a portable device that a user in general always carries with them, by using a function provided in many existing portable devices, security and convenience can be ensured by addition of only a small number of functions.

In addition, as shown in FIGS. 6 and 7, in the initial setting sequence, a portable device to be used for authentication and the number of retransmissions can be set for a PC. If necessary, a pattern to be used for authentication can be verified by the PC and the portable device.

In addition, if it is confirmed that the PC is used by an authorized user, the user can perform changing or resetting of the portable device to be used for authentication and the number of retransmissions by changing or resetting setting items regarding initial settings.

The PC dials the telephone number of a portable device registered in advance in the PC, and the portable device performs a pattern operation registered in an address book. When a valid pattern is detected, the PC is started.

The PC is capable of detecting a vibration pattern of a portable device. A 3D acceleration sensor installed as an HDD protection of a mobile PC or a new acceleration sensor may be used for detecting a vibration pattern. In either case, determination of whether or not the portable device placed on the PC is vibrating can be performed. In this case, a vibration pattern can be detected by checking the states of “1” and “0” at specified timings during a specified time while a state in which the portable device vibrates is represented by “1” and a state in which the portable device does not vibrate is represented by “0”. For example, if the state of the portable device is monitored during six seconds and the state is checked every second, 64 patterns (2⁶=64), as well as the patterns described in this embodiment, can be set.

In an authentication system in which a vibration pattern of a portable device is used for authentication, by stopping the use of the portable device or canceling the contract of the portable device by remote operation, the portable device is set to be in a communication disabled state and startup of the PC cannot thus be performed. Accordingly, various security functions can be obtained.

For example, if only a PC is stolen, unauthorized use of the PC can be avoided by the above-described authentication system. If both a PC and a portable device are stolen at the same time, the stolen portable device is set to the communication disabled state by activation of a lock function of the portable device, cancellation of the contract of the portable device, or the like by remote operation. Accordingly, unauthorized use of the stolen PC can be avoided.

In the authentication system 2, authentication is performed automatically without using unit for entering a password for authentication for startup of a PC. In addition, by using a portable device for user authentication, unauthorized use can be easily avoided without requiring a user to carry a new device for authentication with them and without providing the PC with a new function for remotely avoiding unauthorized use.

### Other Embodiments

(1) Although the PC 4 is illustrated as an apparatus to be authenticated in the above-described embodiments, the apparatus to be authenticated may be any type of apparatus as long as it is an electronic apparatus having a telephone communication function. The present technique is not limited to the PC 4.

(2) Although the portable device 6 is used in the above-described embodiments, any type of device may be used as long as it is an electronic device having a telephone communication function. The present technique is not limited to the portable device 6.

(3) Although authentication is performed by causing the portable device 6 to generate a vibration pattern registered in advance in the above-described embodiments, the present technique is not limited to this. For example, authentication information transmission unit for transmitting authentication information to the PC 4 may be provided as an electronic apparatus to be authenticated, the portable device 6 may receive a vibration pattern as the authentication information transmitted from the authentication information transmission unit, and the vibration pattern may be registered in the portable device 6. In this case, in response to an incoming call from the PC 4, the portable device 6 may be caused to generate vibrations having the vibration pattern so that authentication is performed in accordance with the vibration pattern.

According to the present technique, the advantages described below can be achieved.

(1) Personal authentication can be performed only by originating a call to a portable device without requiring setting of a password or a password entry operation. Thus, facilitation of authentication and improvements in the security and convenience of an electronic apparatus can be achieved.

(2) Unauthorized use can be avoided without requiring a user to carry a device dedicated to authentication with them and without providing the electronic apparatus to be authenticated, such as a PC, with a function of avoiding unauthorized use.

Other objects, features, and advantages of the present technique will become more apparent with reference to the attached drawings and each of the above-described embodiments.

Technical ideas extracted from the above-described embodiments of the present technique are listed below as appendixes according to the form of claims. The technical ideas of the present technique can be understood at various levels and in many variations, on the basis of from broad concepts to narrow concepts.

The present technique is useful in terms of being capable of performing automatic authentication by using a telephone communication pattern of an electronic apparatus and a vibration pattern generated by a portable device in response to an incoming call, performing personal authentication only by call origination to the portable device without requiring setting of a password or entry of a password, and achieving facilitation of authentication and improvements in the security and convenience of the electronic apparatus.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An authentication system comprising:
a communication unit that originates a call on the basis of an entered telephone number;
a vibration reception unit that receives vibrations generated by a portable device in response to an incoming call;
a vibration pattern registration unit registering a vibration pattern; and
an authentication unit that performs authentication by determining whether or not a vibration pattern of the vibrations received by the vibration reception unit matches the vibration pattern registered in the vibration pattern registration unit.

2. The authentication system according to claim 1,
wherein the portable device includes a vibration pattern registration unit for registering a vibration pattern corresponding to an incoming call, registers a vibration pattern representing the incoming call from the communication unit in the vibration pattern registration unit, and generates vibrations having the vibration pattern representing the incoming call from the communication unit.

3. The authentication system according to claim 1,
wherein the portable device includes a vibration pattern generation unit for generating a desired vibration pattern, and generates vibrations having a specific vibration pattern in accordance with incoming call information from the communication unit.

4. The authentication system according to claim 1, further comprising an authentication information transmission unit for transmitting authentication information,
wherein the portable device generates vibrations having a vibration pattern representing the authentication information transmitted from the authentication information transmission unit.

5. An electronic apparatus comprising:
a communication unit that originates a call on the basis of an entered telephone number;
a vibration reception unit that receives vibrations generated by a portable device in response to an incoming call;
a vibration pattern registration unit for registering a vibration pattern; and
an authentication unit that performs authentication by determining whether or not a vibration pattern of the vibrations received by the vibration reception unit matches the vibration pattern registered in the vibration pattern registration unit.

6. The electronic apparatus according to claim 5, wherein the electronic apparatus is started in accordance with an authentication result output from the authentication unit.

7. The electronic apparatus according to claim 5,
wherein the portable device includes a vibration pattern registration unit for registering a vibration pattern corresponding to an incoming call, registers a vibration pattern representing the incoming call from the communication unit in the vibration pattern registration unit, and generates vibrations having the vibration pattern representing the incoming call from the communication unit.

8. The electronic apparatus according to claim 5,
wherein the portable device includes a vibration pattern generation unit for generating a desired vibration pattern, and generates vibrations having a specific vibration pattern in accordance with incoming call information from the communication unit.

9. The electronic apparatus according to claim 5, further comprising an authentication information transmission unit for transmitting authentication information,
wherein the portable device generates vibrations having a vibration pattern representing the authentication information transmitted from the authentication information transmission unit.

10. An authentication method performed by an electronic apparatus, comprising:
originating a call on the basis of an entered telephone number;
receiving vibrations generated by a portable device in response to an incoming call; and
performing authentication by determining whether or not a vibration pattern of the vibrations received by a vibration reception unit matches a vibration pattern registered in first vibration-pattern-registration unit.

11. The authentication method according to claim 10, further comprising:
registering a vibration pattern representing a call originator in second vibration-pattern-registration unit; and
reading the vibration pattern registered in the second vibration-pattern-registration unit in response to an incoming call and generating vibrations having the vibration pattern.

12. The authentication method according to claim 10, further comprising:
generating vibrations having a vibration pattern representing the authentication information in response to authentication information transmitted from the electronic apparatus with the portable device.

13. The authentication method according to claim 10, further comprising:
transmitting authentication information with the electronic apparatus; and
generating vibrations having a vibration pattern representing the authentication information in response to the authentication information with the portable device.

14. The authentication method according to claim 10, further comprising:
starting the electronic apparatus in accordance with an authentication result.

15. A computer-readable recording medium on which an authentication program for authentication of an electronic apparatus to be executed by a computer is recorded, the recording medium causing the computer to perform a process comprising:
originating a call on the basis of an entered telephone number;
receiving vibrations generated by a portable device in response to an incoming call; and
performing authentication by determining whether or not a vibration pattern of the vibrations received by a vibration reception unit matches a vibration pattern registered in first vibration-pattern-registration unit.

16. The recording medium according to claim 15, the process further comprising:
registering a vibration pattern representing a call originator in second vibration-pattern-registration unit; and
reading the vibration pattern registered in the second vibration-pattern-registration unit in response to an incoming call and generating vibrations having the vibration pattern.

17. The recording medium according to claim 15, the process further comprising:
generating vibrations having a vibration pattern representing the authentication information in response to authentication information transmitted from the electronic apparatus with the portable device.

18. The recording medium according to claim 15, the process further comprising:
transmitting authentication information with the electronic apparatus; and
generating vibrations having a vibration pattern representing the authentication information in response to the authentication information with the portable device.

19. The recording medium according to claim 15, the process further comprising:
starting the electronic apparatus in accordance with an authentication result.
